(19) United States
(12) Patent Application Publication
(10) Pub. No.: US 2008/0015945 A1
(43) Pub. Date: Jan. 17, 2008

(54) System and Method for Processing Subscriptions and Periodically-Billed Services

(76) Inventor: Michael Goldstein, Washington, DC (US)

Correspondence Address: MAXVALUEIP CONSULTING, 11204 ALBERMYRTLE ROAD, POTOMAC, MD, 20854, US

(21) Appl. No.: 11/456,910

(22) Filed: Jul. 12, 2006

(51) Int. Cl. G06Q 30/00

(52) U.S. Cl. 705/26

(57) ABSTRACT

This relates to a method and system for processing subscriptions and periodically-billed services. It shows different methods by the way of examples. It improves the e-commerce by increasing the traffic and amount of transactions between interested parties. One goal of the current business is to form partnerships with the largest online merchants, to integrate digital content subscriptions into their product offerings. It provides a method to receive these orders electronically from the merchant and pass them to the content provider to activate the customer's subscription.

### BACKGROUND OF THE INVENTION

With the increase use of computers and the Internet around the world, it is easier for people to distribute the content and information to potential consumers. This invention addresses one of these issues, which relates to a method and system for processing subscriptions and periodically-billed services.

Prior art failed to teach the features of the current invention. For example, U.S. Pat. No. 6,542,874 by Walker et al., U.S. Pat. No. 6,343,275 by Wong, U.S. Pat. No. 6,473,740 by Cockrill et al., U.S. Pat. No. 7,028,300 by Goldick, U.S. Pat. No. 6,733,387 by Walker et al., U.S. Pat. No. 6,711,549 by Loeb et al. (of Synapse Group, Inc.), U.S. Pat. No. 6,421,652 by Loeb et al., U.S. Pat. No. 6,415,262 by Walker et al. (of Walker Digital, LLC), U.S. Pat. No. 6,167,435 by Druckenmiller et al., and U.S. Pat. No. 6,332,124 by Loeb et al. teach models/systems different from the current invention (and its variations/ embodiments).

Another prior art is Amazon.com web site, where they offer The Wall Street Journal Online, with a one-year subscription. The major difference is that, for the Amazon.com web site, the information is not transmitted to a third-party. Therefore, it is very different from our invention.

### SUMMARY OF THE INVENTION

This invention relates to a method and system for processing subscriptions and periodically-billed services. It teaches different methods by the way of examples. It improves the e-commerce by increasing the traffic and amount of transactions between interested parties. One goal of the current business is to form partnerships with the largest online merchants, to integrate digital content subscriptions into their product offerings. It provides a method to receive these orders electronically from the merchant and pass them to the content provider to activate the customer's subscription.

### BRIEF DESCRIPTION OF THE DRAWINGS

FIG. 1 shows the solution overview.

FIG. 2 shows the first part of the technical overview.

FIG. 3 shows the second part of the technical overview.

FIG. 4 shows the Administration (Admin.) Tool.

### DETAILED DESCRIPTION OF THE PREFERRED EMBODIMENTS

### Business Overview:

### Solution Strategy: Order Processing Platform:

In one embodiment, the goal of the current business (let's call it “OurBusiness”) is to form partnerships with the largest online merchants, to integrate digital content subscriptions into their product offerings. It will provide a method to receive these orders electronically from the merchant and pass them to the content provider to activate the customer's subscription. Both the merchant and OurBusiness will receive a revenue share for each order, while the content provider benefits from the leads generated from the additional marketing channels. Customers will also benefit from a 30-day money back guarantee for any digital subscription orders placed through the merchant.

The same engine/system can also be used for other applications, for example, raising e-fund, such as the ones used for kids in school projects.

### High-Level Requirements:

### A. Order Processing Platform:

In one embodiment, OurBusiness order processing platform supports the following primary functions:

Receive/validate individual or batch orders from online merchants for digital subscription services 24×7×365

Receive/validate individual or batch cancellations from online merchants 24×7×365 for customer-initiated cancellations requested within 30 days of the order

Store customer/order data in OurBusiness databases, for reporting, analysis, and customer service

Submit orders/cancellations to content providers within an hour of receiving them from merchants

Report any errors encountered during the receipt and processing of order/cancellation requests to merchants and content providers

### B. Administration Tool:

In one embodiment, OurBusiness administration tool is necessary to manage the following activities in support of the order processing platform:

Set up and maintain merchant and content provider profiles

Generate schema for merchants to use for submitting orders/cancellations to OurBusiness

Map content provider data to the OurBusiness database

Research customer/order details

Generate/manage invoices (including applicable refunds) to merchants and content providers

Produce a check file for paying merchants/content providers

Provide business analysis reporting

### Key Design Objectives:

In one embodiment, the following objectives were considered as a part of the overall design of the OurBusiness solution:

The solution should be flexible and extendible enough to support the variable data requirements and file formats for each content provider to receive orders and cancellations requests from the merchant via OurBusiness.

The processes for receiving orders/cancellations from merchants and for submitting orders/cancellations to content providers (including all sub-processes for extracting, storing, and transforming data) should be automated.

The solution should be designed with validation points/error handling at each hand-off to minimize the potential for data loss and integrity issues.

The solution should be designed to allow processing of orders/cancellations 24-hours a day, 365 days a year. System monitoring scripts and logging should be utilized to provide OurBusiness administrators with the notification and details necessary to maintain the availability and accuracy of the order processing services.

The solution should be designed to process orders/cancellations (either as individual or batch items) from the merchant and submit them to content providers within an hour of receipt. In addition, the solution should be designed to scale easily to support the growth of OurBusiness's business.

All data submitted between the merchant, OurBusiness, and the content providers should be over a secure channel and/or encrypted using an industry-standard data encryption method. All sensitive customer information (e.g. credit cards) should be encrypted while stored in OurBusiness databases.

The recommendations contained within this document are dependant upon the following:

In order to receive the 30-day money-back guarantee, customers will need to cancel subscriptions within the first 30 days of their membership through the merchant. OurBusiness will not be responsible for processing cancellations through to the merchant if the customer cancels directly with the content provider.

The revenue for merchants and OurBusiness will be based upon a one-time fixed payment for each new customer subscription generated—not as a recurring payment for each month a customer maintains the subscription.

OurBusiness will utilize vendor software for producing checks for paying merchants/content providers. It is assumed that this software will accept a compliant check file produced by an external system.

The actual method for submitting orders and cancellations (including encryption and error handling) to content providers is dependant upon the specific requirements of the content provider.

Content providers will only require one schema/file format to support all subscriptions services and/or payment terms.

### Solution Overview: General Order/Cancellation Process:

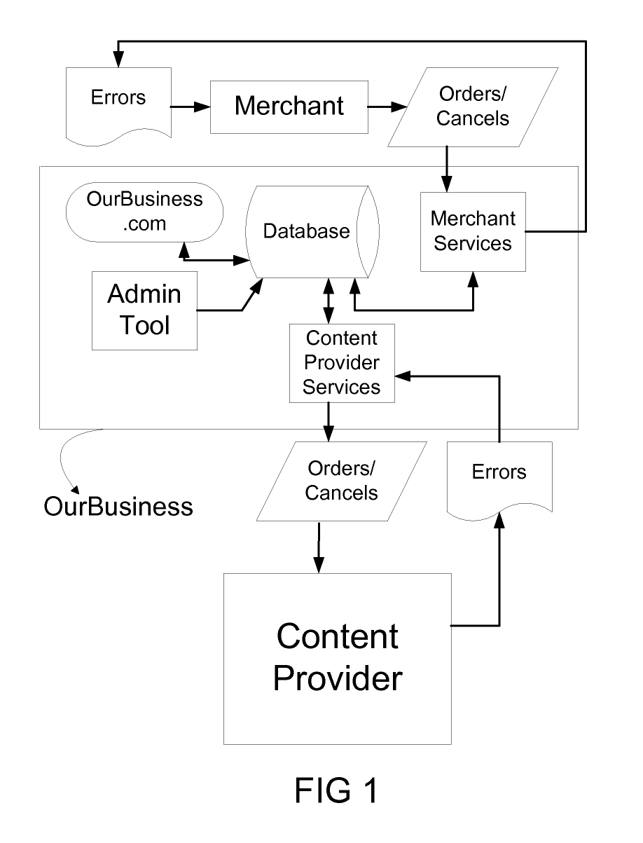

In one embodiment, the flow chart of FIG. 1 outlines the high-level activities that merchants, OurBusiness, and content providers will need to perform as a part of processing digital subscription orders and cancellations.

For one embodiment, for account subscription, the merchant, OurBusiness, and content provider have the following relationship, with OurBusiness being in the middle (see FIG. 1):

Merchant performs the following tasks:
1. Offer subscription product on-site.
2. Integrate any additional field collection within checkout process.
3a. Monthly term: process first monthly charge.
3b. Annual term: process annual charge.
4. Pass customer/order data to OurBusiness.
5. Receive success/error response from OurBusiness.
6. Message customer that they will receive email from content provider upon account activation (within 24 hours).

OurBusiness performs the following tasks:
1. Validate/store order data in OurBusiness database.
2. Format/send order data to content provider.
3a. Monthly term: invoice content provider.
3b. Annual term: invoice merchant.

Content provider performs the following tasks:
1. Process sign-up including schedule recurring payment.
2. Sends account activation email to customer.
3a. Monthly term: pay OurBusiness.
3b. Annual term: invoice OurBusiness.

For account cancellation (within 30 days, for example), the merchant, OurBusiness, and content provider have the following relationship, with OurBusiness being in the middle (see FIG. 1):

Merchant performs the following tasks:
1. Refund customer.
2. Notify OurBusiness of cancellation.
3. Receive success/error response from OurBusiness.
4. Message customers that they will receive email from content provider confirming account cancellation (within 24 hours, e.g.).

OurBusiness performs the following tasks:
1. Record cancellation in OurBusiness database.
2. Format/send cancellation to content provider.
3a. Monthly term: no invoice/refund.
3b. Annual term: invoice content provider, refund merchant.

Content provider performs the following tasks:
1. Cancel subscription and recurring payment.
2. Notify customer via email of cancellation.
3a. Monthly term: no invoice/refund.
3b. Annual term: refund OurBusiness.

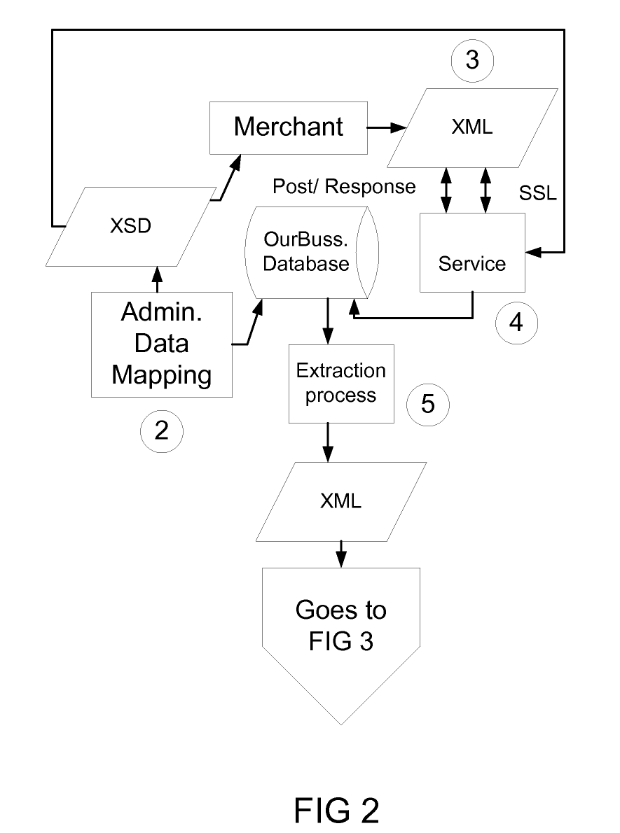

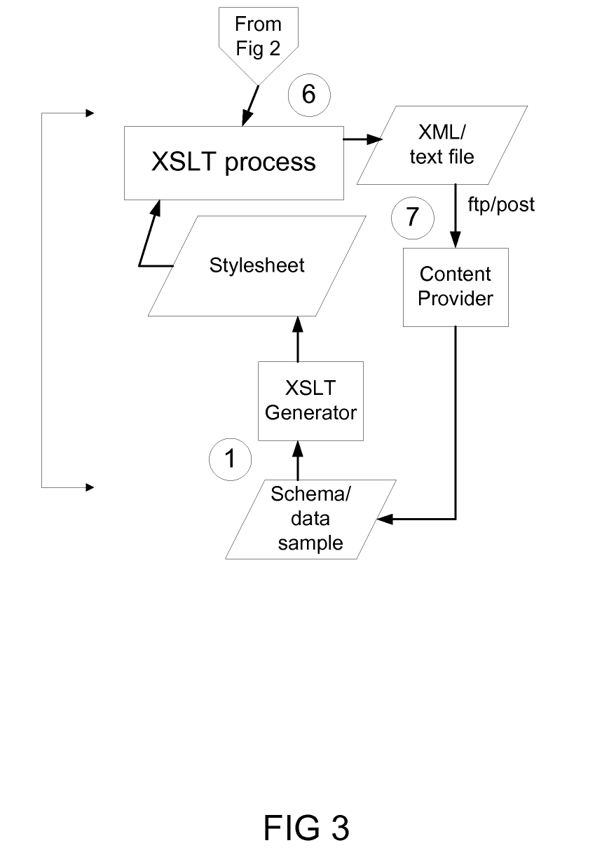

For one embodiment, the flow chart shown in FIGS. 2-3 outlines the data management processes/services for the OurBusiness order processing platform.

The recommendation to use XML for receiving orders/cancellations from merchant will allow OurBusiness to provide merchants a flexible, but standardized method that does not require heavily customized approaches to support each content provider. This is especially important for merchants supporting multiple content providers. In addition, by using XML, OurBusiness can more readily perform file and data validation, as well as ensure proper data mapping to OurBusiness databases, without having to develop heavily customized routines to support each new merchant. Finally, XML has been fairly universally adopted and it is expected that most content providers will also prefer to use this format for data exchange, given its flexibility.

The use of web services will allow OurBusiness to provide a secure (via SSL), real-time, 24×7 method to merchants for posting individual or batch orders/cancellations. The web services will also allow for online success/error responses to merchants.

For one embodiment, the following refers to the steps numbered/described in FIGS. 2-3:

1. Optional: Content provider sends OurBusiness a schema/sample data file that is used to develop a XSLT stylesheet for producing a customized XML or text file. Stylus Studio (www.stylusstudio.com) is an off-the-shelf solution to support XSLT generation.

2. OurBusiness develops a XML Schema Document (XSD) for merchants by mapping content provider data to the OurBusiness database. This schema may be used by any merchant offering the content provider's subscription product.

3. The merchant submits the XML file containing order/cancellation data to OurBusiness via a service (TBD: HTTP Post, REST, SOAP, XML-RPC) over a SSL-secured channel. Additional encryption of credit card (and other sensitive data) may be implemented as appropriate.

4. The OurBusiness service will authenticate the merchant, validate the XML data file, return a success/error response, and process the order/cancellation data into the OurBusiness database. Credit card data will be encrypted, while stored in the database.

5. A scheduled extraction process will pull all un-submitted orders/cancellations to produce a XML data file for each content provider. The extraction job will refer to mapping tables populated via the Admin tool, to translate data values stored in the OurBusiness database to those required by the content provider.

6. The XML data file will be run through a XSLT processor for formatting to a content provider-specific output (XML or text file) using the XSLT stylesheet previously generated.

Note: OurBusiness may offer the content provider the option of using the XML file, produced by the extraction job as a standardized offering, if the content provider does not have specific formatting requirements for the data.

7. The XML or text file will be sent to the content provider to either an ftp server, or posted to a web service, provided by the content provider. The method of file transmission (including encryption) needs to be defined through direct discussion with the content provider. Alternatively, OurBusiness can designate an ftp server for posting these files that the content provider can access to process these files.

### Order/Cancellation Receipt:

In one embodiment, merchants will submit a XML file containing orders or cancellations to a OurBusiness service, either as individual items or in batch. The XML submission will be validated against the schema specifically configured for the content provider, and return a success/error response for the file. The validations will ensure that all required fields and pre-defined values/restrictions have been received from the merchant before the data is processed into the OurBusiness system, or sent to the content provider.

The XML file will then be parsed and processed one item at a time via a schedule batch process. Error records will be split from valid records and sent back to a merchant contact via email for correction and re-submission. Processing these items in batch is an initial recommendation to manage system performance that can be re-evaluated based upon the anticipated order volume.

### Order/Cancellation Extraction and Formatting

Scheduled jobs will run every 15 minutes (as an example) to process new orders/cancellations posted to the OurBusiness database. The jobs will perform the following tasks:
Extract un-submitted orders/cancellations for each content provider.
Translate fields/values per content provider specifications, using mapping defined via the Admin tool.
Format data into a standardized XML file.
Submit XML to the XSLT processor for conversion to a content provider-specified file format (XML or text) using the stylesheet built through the XSLT generator.

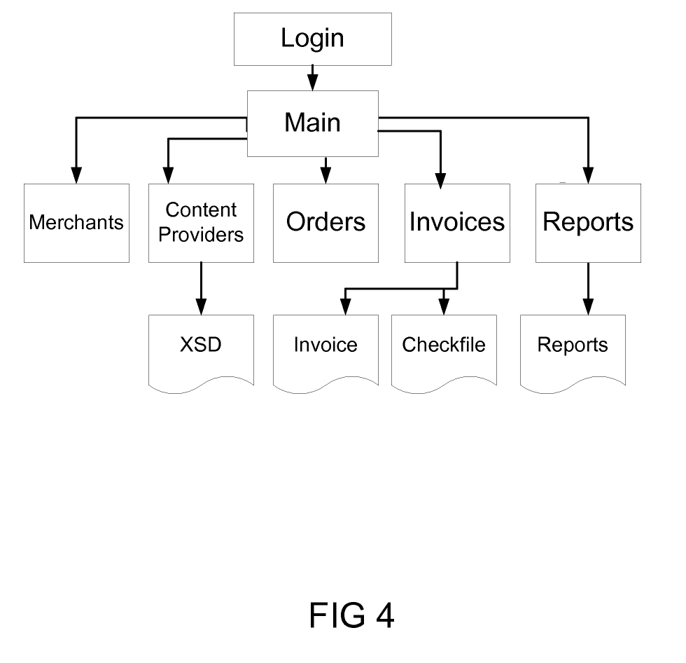

A OurBusiness administration tool is provided to support the setup of new merchants and content providers, along with invoice management and reporting necessary to manage the order processing platform. The modules shown in FIG. 4 are supported.

The Merchant Management module will be used to add, view, and edit merchant profiles. A merchant profile will contain the following information:

Merchant Name & ID

Merchant Address

Contact Information
Primary
Customer Service
Technical Support

Subscription Services
Content Provider Service
Commission Plan
   Monthly
   Annual

Invoice Schedule

The Content Provider Management module will be used to add, view, and edit content provider profiles. In addition, screens will be provided to define the schema (XSD) used by merchants to submit orders/cancels to OurBusiness. These screens also establish the mapping between the OurBusiness fields/values to the fields/values required by the content provider. The content provider profile will contain the following:

Content Provider Name & ID

Content Provider Address

Contact Information
Primary
Customer Service
Technical Support

Invoice Schedule

Services/Product Profile
Category
Service/Product Name
Description
Pricing
   Monthly
   Annual

Create Schema
Data Map
   Product/Service
      Orders
      Cancellations
   Format (XSLT template)

The Create Schema screens is used to produce the schema (XSD) used by all merchants to submit orders and cancellation requests to OurBusiness. In addition, these screens will map the specific values required by the content provider to the standardized values within the OurBusiness database.

The Order Management screens will be used by OurBusiness to research customer and order information to handle any customer service related matters. These screens provide view-only capabilities to identify orders/cancellations by merchant, customer, content provider, and/or date. All order details stored within the OurBusiness database will be available for viewing.

The Invoice Management screens will be used by OurBusiness to manage both invoices received from content providers, as well as generate invoices to merchants. In addition, payment status will be maintained for these invoices.

Invoices Generation: The generation of invoices to merchants/content providers will be managed by a schedule job that will produce an invoice containing all charges for the period. The ability to view and manually re-generate these invoices will also be provided. Once payment has been received, OurBusiness will manually update the payment status for the invoice.

Invoice Receipt: Screens will be provided to allow OurBusiness to enter details for invoices received from merchants/content providers, as well as produce a payment check file for import into a third-party accounting software. The status of the invoice can be updated either manually or automatically, as a result of producing the check file.

Note: Ideally, OurBusiness would arrange an agreement with merchants and content providers to allow for net invoicing, in order to avoid having to have merchants/content providers invoice OurBusiness for any refunds resulting from cancellations.

The following general reporting is available for viewing and output (Word, Excel) through the Reporting module:

Invoicing Reports—reports on the amounts (charges and refunds) invoiced or paid to merchants and content providers.

Activity Reports—reports on the number of orders, cancellations, and errors processed by merchants and content providers.

Note: Each report will be configurable to allow OurBusiness the ability to filter by merchant, content provider, and/or date range.

The hardware recommendation (an example for system architecture) for the OurBusiness order processing platform is intended to provide an infrastructure that offers the level of security and performance necessary for a 24×7 e-commerce business. The following configuration is recommended:

The firewall device provides network security, restricting access to predefined, secure clients only and to allowed ports.

Load balanced devices allow for one server to be unavailable due to planned (e.g., software upgrade) or unplanned downtime (e.g., hard disk, crash.).

The staging server provides pre-deployment testing and post-deployment problem analysis.

A replicated database server allows for unplanned downtime and system maintenance similar to the load balanced web servers.

### EXAMPLES

(In the examples below, Buy.com is the Merchant and Audible.com is the Content Provider.)

### Example 1

### Flow of Data (Best Case Scenario—With No Errors—Monthly Charge Scenario)

Customer buys Ipod at Buy.com for $100.

At checkout he/she is offered a subscription to Audible.com at $10 per month.

Customer buys both by credit card.

Buy.com sends customer information including credit card info to OurBusiness.

OurBusiness sends customer information including credit card info to Audible.com.

Audible.com sends an email to the customer specifying username (usually email address) and password (usually order number).

Second month onwards, Audible.com charges $10 per month to the credit card. (Note: We always need credit card information for monthly charge orders. In fact, gift cards cannot be used to buy monthly charge services; gift cards can only be used to buy annual charge services.)

### Example 2

### Monthly Charge Scenario (Best Case—With No Errors and No Cancellations)

Assumption 1: Per Month Charge is $10.

Assumption 2: The money splits as follows:

Total 12 month charge $120:
(Buy.com $10; OurBusiness $20; Audible.com $90)
Buy.com charges $10
Buy.com keeps the $10 charge
OurBusiness invoices $20 Audible.com
Audible.com invoices $10 for the next 11 months (that makes them $110, but after paying OurBusiness $20, their net is $90)

### Example 3

### Flow of Money

Annual Charge Scenario (Best case—with no errors and no cancellations)

Assumption 1: Annual charge is $100

Assumption 2: The money splits as follows:
Total 12 month charge $100
(Buy.com $30; OurBusiness $25; Audible.com $45)
Buy.com charges $100
OurBusiness invoices Buy.com $70, (So Buy.com nets $30)
Audible.com invoices $45 to OurBusiness. (So OurBusiness nets $25, which is $70−$45)

### Example 4

### TimeLine—Best Case Scenario

10:01 AM Person goes to www.buy.com

10:10 AM Person places order

10:20 AM Buy.com puts the order on ftp location

10:30 AM OurBusiness Input robot picks up the order

10:31 AM OurBusiness system reformats the order using Audible.com-defined format

10:32 AM OurBusiness Output robot sends the order to Audible.com

10:33 AM Audible.com system creates a new subscription account

10:34 AM Audible.com sends email to Customer, asking him/her to use order ID as password

### Example 5

### Cancellation Scenarios

Monthly charge scenario—Cancellation within the first 30 days:

Customer Point of View: Entire amount gets refunded: Nets zero

Merchant Point of View: Refunds entire amount to customer: Nets zero.

Content Provider Point of View: Pays OurBusiness $20 bounty: Loses $20

OurBusiness Point of View: Still gets paid by Content Provider: Gains $20

### Example 6

### Monthly Charge Scenario—Cancellation After Initial 30 Days

Customer Point of View: Is redirected to ContentProvider to cancel: Loses all money that has already been charged: but will not be charged after that cancellation.: Loses 10* n dollars

Merchant Point of View: Doesn't need to do anything, just redirect customer, the initial $10 charged does not need to be refunded: Nets $10.

Content Provider Point of View: Already paid OurBusiness $20 bounty, but was expecting to make $110 by charging from the 2^{nd} to the 12^{th} month, with a net of $90. If the cancellation happens within the 2^{nd} month, loses $10. If cancellation happens in 3^{rd} month, nets zero. If cancellation happens in the 4^{th} month, nets $10. (in 5^{th} month, nets $20, and so on.)

OurBusiness Point of View: Still gets paid by Content Provider: Gains $20

### Example 7

### Annual Charge Scenario—Cancellation Within the First 30 Days

Customer Point of View: Entire amount gets refunded: Nets zero

Merchant Point of View: Refunds entire amount to customer: Nets zero.

Content Provider Point of View: Gets refunded the $25 it paid OurBusiness as bounty: Nets zero

OurBusiness Point of View: Refunds the $25 it was paid by the ContentProvider. Also refunds the Merchant any money received: Nets zero

### Example 8

### Annual Charge Scenario—Cancellation After Initial 30 Days

Customer Point of View: Is redirected to ContentProvider to cancel where he/she is given a pro-rated refund: Loses (n/12*100)

Merchant Point of View: Doesn't need to do anything, just redirect customer, the initial $100 minus $70 paid to OurBusiness does not need to be refunded: Nets $30.

Content Provider Point of View: Already paid OurBusiness $25 bounty, but was expecting to net $45, after $30 for Merchant and $25 for OurBusiness. If the cancellation happens within 6 months, refunds $50 and loses $5. After that, if cancellation happens in any month thereafter, nets some money.

OurBusiness Point of View: Still gets paid by Content Provider: Gains $25

### Table Design—Examples

Field types will be defined later, based on type of Text, number, currency, Yes/No fields

### Table: Customers

ID

FirstName

LastName

Address1

Address2

City

State

Zip

Country

Email

PhoneNumber

### Table: Orders

ID

CustomerID (Lookup table: Customers)

ShipToCustomerID (Lookup table: Customers) (If empty, then Customer is the same as ShipToCustomer)

PaymentType (Lookup table: PaymentTypes, with values Credit Card, PayPal, etc.)

PaymentAmount

ServiceID (Lookup table: Services)

CreditCardType (Lookup table: CreditCardTypes, with values MasterCard, Visa, etc.)

CreditCardNumber

CreditCardExpiry

MerchantID (Lookup table: Merchants)

MerchantTransactionID

PromotionCode (Lookup table: Promotions)

DateAndTimeCustomerPlacedOrder (at Merchant)

DateAndTimeOrderReceivedByOurBusiness

DateAndTimeOrderSentToContentProvider

DateAndTimeOrderConfirmedByContentProvider

### Table: Services

ID

ContentProviderID (Lookup Table: ContentProvider, e.g. Audible.com)

Name (e.g. Audible.com Monthly Service, Audible.com Annual Service, Audible.com Plus Service, etc.)

Term (LookupTable: Terms with values, Annual, Monthly)

SKU

### Table: Budget

(For example, Service A: January 2007—budgeted volume 100, February 2007—budgeted volume 200, etc.)

ID

ServiceID (Lookup table: Services)

MonthYear (e.g. January 2007, February 2007, March 2007, etc.)

NumberOfSalesPerMonth (100, 200, 300, etc.)

### Table: Merchants

ID

Name

Address1

Address2

City

State

Zip

Email

Fax

MonthlyServiceCommision (e.g. 100%—So for every $10 they charge they keep $10)

AnnualServiceCommission (e.g. 20%—So for $100 they charge, they keep $20, we invoice $80)

InvoiceDetails (e.g. Invoice every month, Invoice beginning of month)

MainContactID (Lookup table: Contacts) (The highest level contact we have access to)

InvoicingContactID (The person to whom we send invoices)

EmailContactID (The person to whom we send invoices)

CustomerServiceContactID (The person who can be contacted, if there is a Customer Service issue)

TechContactID (The person to whom we take any tech issues)

RefundDetails (To be taken care of later)

### Table: Promotions

ID

Name (e.g. TabDisplay, Checkout offer, etc)

MerchantID (Lookup table: Merchants)

### Table: Contacts

ID

Type (Lookup table: ContactTypes: Merchant, Content Provider, Other)

FirstName

LastName

Title

Address1

Address2

City

State

Zip

Email

PhoneNumber

Fax

### Table: MerchantFormats

ID

FormatName

FormatDetails (To be taken care of later)

### Table: ContentProviders

ID

Name

Address1

Address2

City

State

Zip

Email

Fax

CategoryID (Lookup table: Categories)

MonthlyServiceRate (Percentage of 12 month charge)

AnnualServiceRate (Percentage of 12 month charge)

InvoicingNotes (e.g. InvoiceEveryMonth,)

### Table: ContentProviderFormats

ID

FormatName

FormatDetails (To be taken care of later)

### Table: Categories

(Categories of Content Providers)

ID

Name (Technology, Sports, Music, etc)

### Table: InvoiceMaster

ID

InvoiceNumber

InvoiceDate

InvoicedToID (Merchant/Content Provider)

Paid (Yes/No)

### Table: InvoiceDetail

ID

InvoiceMasterID (Lookup table: InvoiceMaster)

ServiceID (Lookup table: Services)

Description

Qty

Rate

### Table: Payments

ID

PaymentFrom (could be Content provider or Merchant)

PaymentDate

InvoiceID (Lookup table: InvoiceMaster)

PaymentAmount

CheckNumber

### Table: Refunds

ID

DateTimeRefundOrderReceived

RefundOrderID (Lookup table: Orders)

OriginalOrderID (Lookup table: Orders)

AmountRefundedToCustomer (could full amount charged, or prorated refund)

RefundRequestWithin30Days (Yes/No field)

### Table: InvoicesReceivedMaster

ID

InvoiceNumber

InvoiceDate

InvoicedBy (Merchant/Content Provider)

Paid (Yes/No)

### Table: InvoicesReceivedDetail

ID

InvoiceMasterID (Lookup table: InvoiceMaster)

ServiceID (Lookup table Services)

Description

Qty

Rate

### Table: PaymentsSent

ID

PaymentDate

InvoiceID (Lookup table: InvoicesReceivedMaster)

PaymentAmount

CheckNumber

### Table: ErrorCodes

ID

ErrorCode (e.g. E101, E102, E103, etc)

ErrorDescription (e.g. No email address, No CreditCard provided, Duplicate from same merchant, Duplicate from another Merchant)

### Table: HoldingTableIn

(All incoming data from the Merchants will first land in this temporary table. Special code might be needed to put data into this table. After that, code would only be needed to be written to work of the holding table.)

### Table: HoldingTableOut

(All outgoing data from the Database to the Content Providers will first be put it into this temporary table. Special code might be needed to take data from this table into various formats.)

### Report Design—Examples:

### Service Listing By Content Provider

Displays all services we can offer, sorted by Content Provider, a Total number of services offered is displayed, at end of report.

### Service Listing By Merchants

Displays all services we offer, sorted by Merchants who are offering them

### Services Utilization

Displays all services against number of merchants offering them. Highlights any merchants not offering any services, and also services not being offered on any merchant. Any product being offered in two places by the same Merchant is counted twice.

### Invoicing report Content Providers—Example:

Content Provider: New York Times

| Service | NumberSold | Commission | Amount |
|---|---|---|---|
| TimeSelect Monthly | 300 | $20 | $6000 |
| TimeSelect Annual | 10 | $25 | $250 |
| Total Amount Invoiced: | $6250 | | |

### Accounts Receivable Report

A report displaying how much money Merchants or Content Providers owe us.

### Accounts Payable Report

A report displaying how much money we have to pay Content Providers.

### YTD Reports—ContentProvider Summary

A report displaying dollars made from various categories of Content Providers, sorted by Months.

| | January | February | March | Total |
|---|---|---|---|---|
| NY Times | $5,000 | $5,500 | $6,000 | $35,000 |
| Brittannica | $8,600 | $8,700 | $9,000 | $40,000 |
| Audible.com | $6,000 | $8,600 | $9,200 | $50,000 |
| — | | | | |
| — | | | | |
| Total | $18,000 | $23,000 | $33,000 | $190,000 |

### YTD Reports—Merchant Summary

A report displaying dollars made from various categories of Content Providers, sorted by Months.

| | January | February | March |
|---|---|---|---|
| Best Buy | $8000 | $5500 | $6000 |
| Buy.com | $9600 | $9700 | $10000 |
| Amazon.com | $7000 | $8600 | $9200 |
| — | | | |
| — | | | |
| Total | $22000 | $33000 | $43000 |

### YTD Reports—Top Three

Top three performers by volume amongst Content Providers

Top three performers by dollars amongst Content Providers

Top three performers by volume amongst Merchants

Top three performers by dollars amongst Merchants

Top three most utilized Services by volume

Top three most utilized Services by dollars

### YTD Reports—Bottom Three

Bottom three performers by volume amongst Content Providers

Bottom three performers by dollars amongst Content Providers

Bottom three performers by volume amongst Merchants

Bottom three performers by dollars amongst Merchants

Bottom three least utilized Services by volume

Bottom three least utilized Services by dollars

### Error Report by Content Provider

Number and type of errors per Content Provider

### Error Report by Merchants

Number and type of errors per Merchant

Refund report per Merchant

Monthly Volume Report for Merchants

Monthly Volume Report for Content Providers

### Content Providers

Allows adding/editing of all content providers, list, volume report, dollar report

### Services

Allows adding/editing of all services, list, volume report, dollar report

### Customers

Lookup Customers for customer service problems.

### Merchants

Allows adding/editing of all merchants, list, volume report, dollar report

### Invoicing

Generate invoices, Enter payments received, Enter invoices received, Create checks

### Weekly Reports

All YTD reports

The teachings given above are just examples of the invention, and any variations of the embodiments and examples above are also intended to be covered and protected by the current patent disclosure.

What I claim as my invention is:

1. A system for processing subscriptions or periodically-billed services, said system comprising:
a merchant;
a content provider;
a customer; and
a middle entity,
wherein said merchant offers one or more subscription products to said customer,
said customer accepts said one or more subscription products offer,
said merchant passes the data related to said customer and said one or more subscription products offer to said middle entity,
said middle entity validates said data related to said customer and said one or more subscription products offer,
said middle entity passes said data related to said customer and said one or more subscription products offer to said content provider, and
said content provider activates said customer's subscription.

2. A system as recited in claim 1, wherein said system further comprises multiple merchants.

3. A system as recited in claim 1, wherein said system further comprises multiple content providers.

4. A system as recited in claim 1, wherein said system further comprises multiple customers.

5. A system as recited in claim 1, wherein said middle entity further comprises administration tools.

6. A system as recited in claim 1, wherein said system further comprises a mechanism for account cancellation.

7. A system as recited in claim 1, wherein said system further comprises a mechanism for error handling.

8. A system as recited in claim 1, wherein said middle entity further comprises one or more databases.

9. A system as recited in claim 1, wherein said one or more subscription products is a subscription to a magazine.

10. A system as recited in claim 1, wherein said one or more subscription products is based on the annual term.

11. A system as recited in claim 1, wherein said one or more subscription products is based on the monthly term.

12. A system as recited in claim 1, wherein said merchant receives a revenue share of each of said accepted said one or more subscription products offer.

13. A system as recited in claim 1, wherein said middle entity receives a revenue share of each of said accepted said one or more subscription products offer.

14. A system as recited in claim 1, further comprising one or more secure channels.

15. A system as recited in claim 1, wherein said system uses XML format.

16. A system as recited in claim 1, wherein said system further comprises a mechanism for generating the refunds.

17. A system as recited in claim 1, wherein said system further comprises a mechanism for generating the invoices.

18. A system as recited in claim 1, wherein said system further comprises data mapping.

19. An apparatus for processing subscriptions or periodically-billed services, said apparatus comprising:
a means for offering one or more subscription products to a customer by a merchant; and
a means for accepting said one or more subscription products offer by said customer,
wherein said merchant passes the data related to said customer and said one or more subscription products offer to a middle entity,
said middle entity validates said data related to said customer and said one or more subscription products offer,
said middle entity passes said data related to said customer and said one or more subscription products offer to a content provider, and
said content provider activates said customer's subscription.

20. A method for processing subscriptions or periodically-billed services, said method comprising the steps of:
offering one or more subscription products to a customer by a merchant; and
accepting said one or more subscription products offer by said customer,
wherein said merchant passes the data related to said customer and said one or more subscription products offer to a middle entity,
said middle entity validates said data related to said customer and said one or more subscription products offer,
said middle entity passes said data related to said customer and said one or more
subscription products offer to a content provider, and
said content provider activates said customer's subscription.
